(19) United States
(12) Patent Application Publication
(10) Pub. No.: US 2012/0096914 A1
(43) Pub. Date: Apr. 26, 2012

(54) METHOD AND DEVICE FOR PROCESSING A SLAB

(75) Inventors: Jürgen Seidel, Kreuztal (DE); Klaus Lazzaro, Kirchhundem (DE)

(73) Assignee: SMS SIEMAG AKTIENGESELLSCHAFT, Düsseldorf (DE)

(21) Appl. No.: 13/379,404

(22) PCT Filed: Aug. 17, 2009
(86) PCT No.: PCT/EP2009/005942

§ 371 Date: Dec. 20, 2011

(30) Foreign Application Priority Data
Jun. 23, 2009 (DE) 10 2009 029 887.8

(51) Int. Cl. B21B 39/14; B21B 45/04; F27B 9/14

(52) U.S. Cl. 72/250; 432/123; 72/203; 72/200; 29/81.03

(57) ABSTRACT

The invention relates to a method for processing a slab (1) in a device, which comprises at least one furnace (2), at least one processing device (3, 4) arranged downstream of the furnace (2) in the conveying direction (F) of the slab (1), and a rolling train (5) arranged downstream of the at least one processing device (3, 4) in the conveying direction (F) of the slab (1), wherein means (6, 7) are provided, by means of which a force can be applied to the sides (8, 9) of the slab (1) in order to move the axis (10) of the slab (1) in agreement with a specified position transversely to the conveying direction (F) of the slab (1), in particular in accordance with the axis (11) of the rolling train (5). In order to optimize the rolling process by precisely introducing the slab into the rolling train, according to the invention first means (6) act on the slab (1) to apply a lateral force to the slab (1) at a first location (12), and second means (7) act on the slab (1) to apply a lateral force to the slab (1) at a second location (13), wherein the second location (13) lies at a distance from the first location (12) in the conveying direction (F) of the slab (1), wherein the first location (12) lies behind the furnace (2) and wherein the second location (13) lies in front of within, or behind the at least one processing device (3, 4). The invention further relates to a device for processing a slab.

The invention relates to a method for processing a slab in a device which includes at least one furnace, at least one processing device arranged in the conveying direction of the slab following the furnace, and at least one roiling train arranged following the processing device in the conveying direction of the slab, wherein means are provided for exerting a force against the sides of the slab in order to be able to move the axis of the slab in accordance with a predetermined position transversely of the conveying direction of the slab, particularly to coincide with the axis of the rolling train. The invention also relates to a device for processing a slab.

In manufacturing a strip from a slab, for example, a thin slab, the latter is transported in a conveying direction through the processing plant. During the transport of the thin slab through a tunnel furnace (roller hearth furnace), the slab can travel to the side. As a result, the subsequent threading in to the finishing train becomes more difficult. An upsetting stand is frequently provided in front of the finishing rolling train. Moreover, lateral guides are usually arranged with the purpose of conducting the slab relative to the axis of the rolling train. The upsetting stand or the mechanical guides must therefore be wide open at their heads and are usually adjusted only after being safely threaded-in to the first horizontal stand of the finishing train to a narrower guide position. Because of the unfavorable conditions or because of the risk that slabs become stuck at the upsetting stand, the upsetting stand at the head of the slab is not used. A late closing of the upsetting stand and a later beginning of the upsetting process would lead to different widths over the strip length.

In order to improve the concentricity of the slab when leaving the furnace, DE 601 01 340 T2 discloses a method of the above type and a corresponding device. Thus, a guide roller centering means is provided in the last furnace portion. In this case, guide rollers are moved for a short period of time into the furnace, wherein the guide rollers contact the slab side and exert a force against this side and center the slab in this manner. However, this is a procedure which is very high in maintenance because the guides are frequently subjected to the high furnace temperature. Another disadvantage is the fact that due to the continuous lateral opening of the furnace for entering the rolls, the furnace atmosphere is negatively influenced. Additional slab scale baking at the furnace roller as well as the additional slab scaling are the consequence. In spite of centering in the furnace, i.e., in the conveying direction behind the furnace, there is still a risk that the slab runs once again sideways after the furnace. In the case of a S-shaped or saber-shaped slab, the centering effect achievable with the known solution is also limited.

With respect to centering of the slab it would be useful if in front of the finishing train a long guide rule were arranged as it is known in preliminary stands. A solution of this type is known from U.S. Pat. No. 2,072,121. An enlargement of the transportation length between furnace and finishing train in order to accommodate a long guide, however, is not possible for reasons of the roll temperature (temperature losses). Moreover, because of the surface quality, it is necessary that a slab descaling takes place as closely as possible in front of the rolling process. In addition, further processing devices, for example, a cutting device must be accommodated between the furnace and the finishing train.

DE 43 10 547 C2 also discloses a solution for centering a slab, however, also in this case several long rulers are used which in the present case cannot be used in front of the finishing train for the reasons stated above. A similar solution is also disclosed in JP 63101004 A.

The present invention is based on the object of proposing a method of the above-described type and a corresponding device by means of which it becomes possible with simple means to precisely center the slab shortly before the rolling train, but particularly in front of the finishing train, and to guide and especially securely upset the slab over the entire slab length. Moreover, a problem-free rolling at the head and the end of the slab are to be ensured. The rolling procedure should be optimized by a precise guiding of the slab into the rolling train. In particular, it is provided that centering and guiding the slab are realized shortly before the finishing train in such a way that no significant extension of the spacing between the furnace and finishing train is created.

This object is met by the invention with respect to the method in that first means for exerting a lateral force on the slab act at a first location on the slab and second means for exerting a lateral force against the slab at a second location act on the slab, wherein the second location is in the conveying direction of the slab at a distance from the first location, wherein the first location is located behind the furnace and wherein the second location is located in front of, within or following the at least one processing device.

A more specific embodiment of the invention provides that the first location is situated behind the furnace and in front of the first of the at least one processing device, and that the second location is situated within or behind the first of the at least one processing device.

Rolling in the rolling train can be a finish rolling of the slab into a strip.

A reliable manner of operation can be ensured if the position of the head of the slab in the area of at least one of the means is detected and the exertion of a lateral force on the slab by closing a contact element of the means is started only when the head of the slab has passed the means.

Immediately in front of the rolling train, the slab can be subjected to an upsetting step in the direction transversely of the conveying direction. In that case, it is preferably provided that the exertion of a lateral force on the slab by the means takes place in front of the location of upsetting and spaced apart from this location.

Accordingly, it can be stated that it is preferably provided that the first means for exerting a lateral force on the slab is arranged behind the furnace and the second means for exerting a lateral force on the slab is arranged at a distance therefrom in front of the upsetting device.

The exertion of a lateral force on the slab by the means preferably takes place in front of the rolling train.

The means for exerting a lateral force on the slab are preferably operated in such a way that the tip of the slab centrally enters the location of the upsetting and/or into the rolling train.

At least two means for exerting a lateral force on the slab can be arranged behind the furnace, wherein the first location is situated between furnace and first processing device and the second location between the at least two processing devices or within the second processing device. In that case, it has been found useful if in the first processing device, the slab is subjected to a cutting process. In the second processing device, the slab is preferably subjected to a descaling process.

A further development provides that the location and/or the shape of the slab are determined transversely of the conveying direction of the slab along its movement in the conveying direction in front of the first location.

The exertion of a lateral force on the slab by the means can be carried out controlled or regulated in such a way that the axis of the slab takes a desired position in the conveying direction behind the second location.

The adjustment of the means for exerting a lateral force on the slab can be determined in dependence on the geometry of the device and/or the determined shape of the slab and/or the eccentricity of the slab and/or the width of the slab with the use of a computer model.

The device for processing a slab which includes at least a furnace, at least one processing device arranged following the furnace in the conveying direction of the slab, and one of the at least one rolling train arranged following at least one processing device in the conveying direction of the slab, particularly a finishing train, as well as means for exerting force on the side of the slab in order to move the axis of the slab to coincide with a predetermined position transversely of the conveying direction of the slab, particularly in coincidence with the axis of the rolling train, it is provided according to the invention that first means for exerting a lateral force on the slab are arranged in a first location and that second means for exerting a lateral force on the slab are arranged at a second location, wherein the second location is in the conveying direction of the slab located at a distance from the first location, wherein the first location is located behind the furnace and wherein the second location is located in front of, within or following the at least one processing device.

It is preferred that the first position is behind the furnace and in front of the at least one processing device and the second position is within or behind a first of the at least one processing device.

The area within the furnace is preferably free of means for exerting a lateral force on the slab.

Immediately in front of the rolling train, an upsetting stand for upsetting the slab in the direction transversely of the conveying direction can be arranged.

Between the upsetting stand and the first roll stand of the rolling train can be arranged lateral guide rulers for centering and guiding the slab. Moreover, adjusting elements of the lateral guide rulers can be arranged below and/or above the lateral guide rollers.

The means for exerting a lateral force on the slab can be arranged spaced from the upsetting stand. It can also be arranged in front of the rolling train.

A further development provides that at least two means for exerting a lateral force on the slab are arranged behind the furnace, wherein the first location is located between furnace and first processing device and the second location between the at least two processing devices or within the second processing device. The first processing device is preferably a cutting device. The second processing device is preferably a descaling device.

The means for exerting a lateral force on the slab can include at least one roller which is arranged at a pivoting arm, wherein the pivoting arm is mounted stationarily at a bearing point and can be pivoted by an actuator which is acting outside of the bearing point at the pivot arm.

The means for exerting a lateral force on the slab can also include at least one roller which is arranged at a linear actuator whose direction of movement is aligned transversely of the conveying direction of the slab.

In both cases, a further development provides that the actuator or the linear actuator is constructed as a hydraulic piston-cylinder system.

The first means for exerting a lateral force on the slab can also be constructed as guide rulers.

The proposed device is preferably a component of a thin slab continuous casting plant. It may also be a component of a hot strip rolling train that includes a roughing train and a finishing train. In this case, the device is preferably arranged in front of the finishing train.

Accordingly, the invention seeks to have a centering and guiding of the slab take place shortly in front of the finishing train with lateral roller guides in such a way that an altogether short distance is between furnace and finishing train. The lateral roller guides are accommodated between the individual units (processing devices) in a suitable distance. Additionally, an upsetting stand and a mechanical or hydraulic lateral guidance are arranged in front of the first roll stand of the finishing train.

The proposed solution is used preferably in the so-called CSP-technology. This is to be understood as the finishing of a steel strip in a thin slab continuous casting plant which facilitates an efficient production of hot strip.

The proposed features make it possible, among others, to increase the yield and to reduce the number of mold adjustments. A direct influence on the width of the slab in front of the finishing train becomes possible. Moreover, the strip travel is improved.

In the drawing, embodiments of the invention are illustrated. In the drawing:

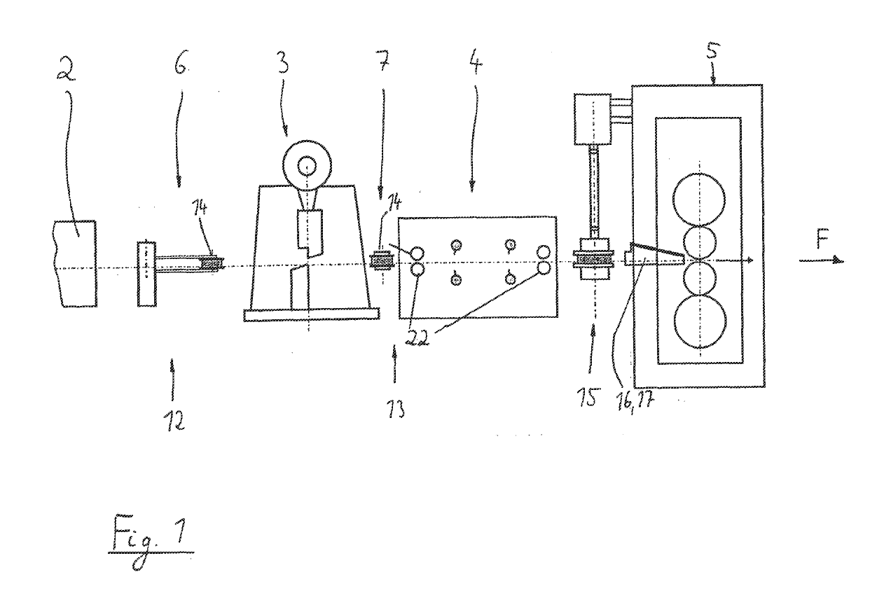

FIG. 1 schematically shows a side view of a device for processing and guiding a slab between an only partially illustrated furnace and the first roll stand of a finishing rolling train;

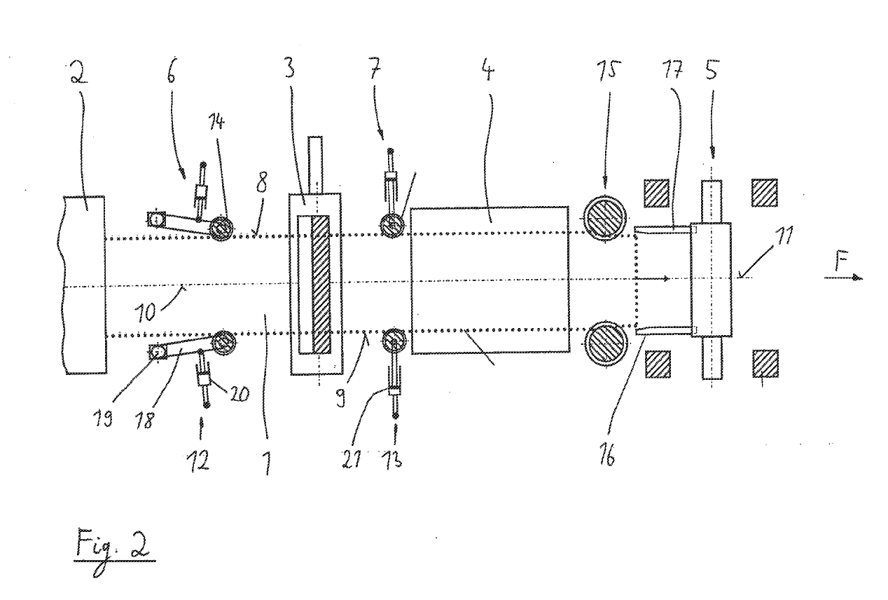

FIG. 2 schematically shows the top view corresponding to FIG. 1;

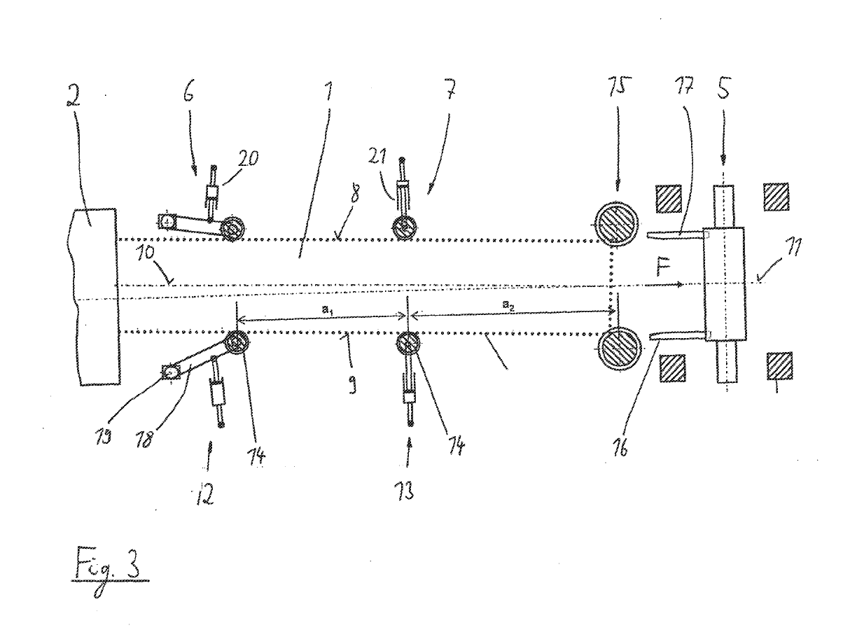

FIG. 3 is a schematic illustration of the slab guiding elements being used analogously to the illustration according to FIG. 2 in a top view of the device;

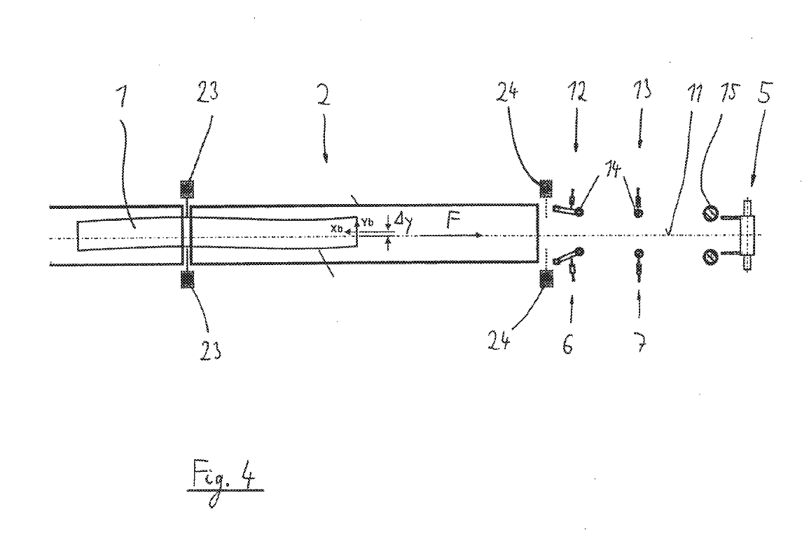

FIG. 4 is an illustration similar to FIG. 3, wherein in this case a greater section of the furnace is shown;

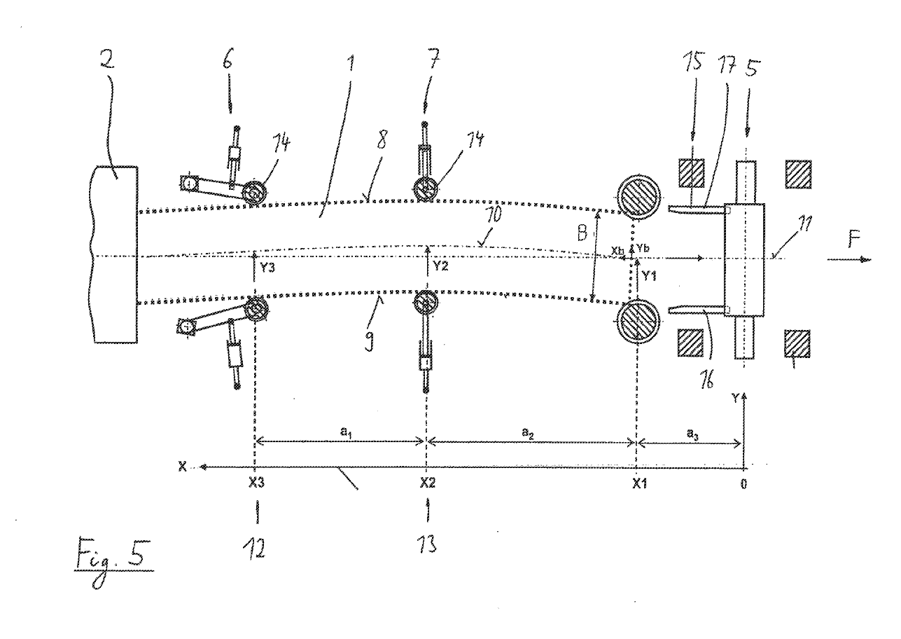

FIG. 5 again schematically illustrates the slab guide elements being used analogously to the illustration according to FIGS. 2 and 3 in a top view of the device with a slab having a greater curvature;

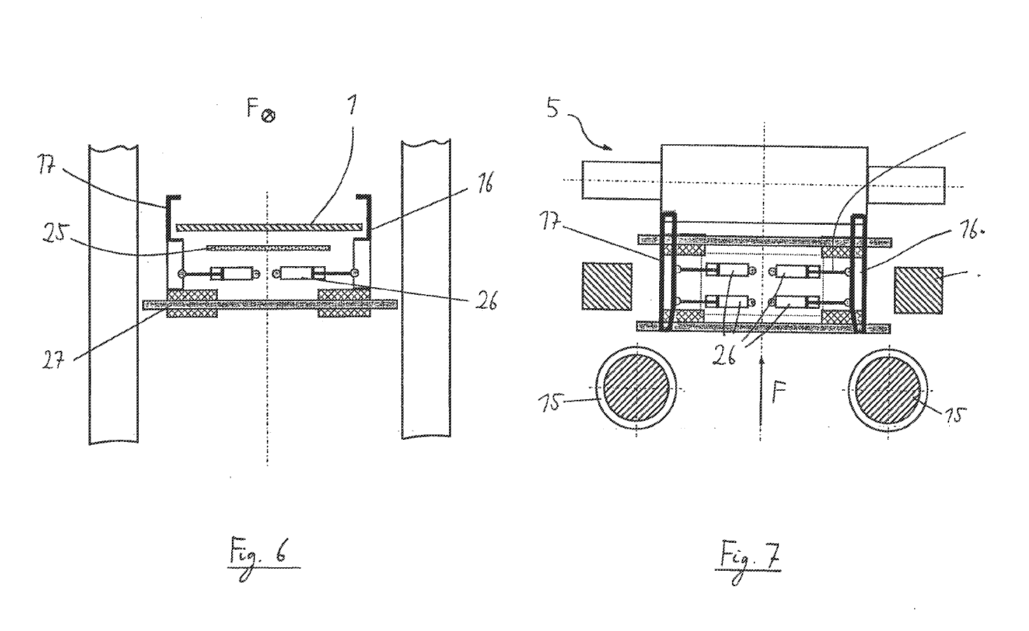

FIG. 6 is a front view, as seen in the conveying direction of the slab, and

FIG. 7 is the top view of the section of the device illustrated in FIG. 6, shown immediately in front of the first roll stand of the finishing train.

FIGS. 1 and 2 show a device by means of which a slab 1 can be processed when being conveyed in the conveying direction F. In concrete terms, an end portion of a furnace is illustrated and a first roll stand of a rolling train 5 between which the slab 1 is conveyed. Between the furnace 2 and the rolling train 5 is arranged a first processing device 3 in the form of a cutting device and a second processing device 4 in the form of a descaling device. Further provided are two means 6 and 7 for exerting a lateral force on the slab 1, i.e., lateral roller guides which are equipped with contact elements in the form of rollers 14, which can be pressed against the sides 8 and 9 of the slab 1 in order to center the slab in such a way that the axis 10 of the slab 1 coincides with the axis 11 of the rolling train 5.

It is significant that the first means 6 for exerting a lateral force on the slab 1 act on a first location 12 on the slab 1 and that the second means 7 for exerting a lateral force on the slab 1 act at a second location 13 on the slab 1. The second location 13 is located in the conveying direction F of the slab 1 spaced from the first location 12; further, the first location 12 is located behind the furnace 2 and in front of the first processing device 3, wherein the second location 13 is located within or following the first processing device 3; i.e., in the embodiment between the two processing devices 3 and 4.

Accordingly, the two means 6 and 7 ensure a centering of the slab, so that the slab centrally enters an upsetting stand 15 which is arranged immediately in front of the first roll stand of the finishing train 5. Additionally provided between upsetting stand 15 and the first roll stand of the finishing train 5 are lateral guide rulers 16 and 17 which further center the slab 1.

As can be seen in FIG. 2, the means 6, 7 may have a pivoting arm 18 which is mounted in a stationary bearing point 19 and which supports the roller 14 at its end remote from the bearing point 19. An actuator 20 engages the pivoting arm 18 and ensures the appropriate adjustment of the roller 14 against the side 8, 9 of the slab. Alternatively, the means 6, 7 may also comprise a linear actuator 21 which places the roller 14 directly linear against the strip edge.

The following shall be explained with respect to the sequence of the method:

When the slab 1 is transported out of the furnace 2 in the direction of the finishing train 5, initially the first linear roller guide 6, i.e., the first means for exerting a lateral force on the slab, is adjusted to excess width. After the slab tip has passed the rollers 14 (detected by hot metal detectors or by a distance follow-up), the rollers 14 are slowly moved toward the sides 8, 9 of the slab, i.e., against the slab edges, and the gap between slab and rollers is closed. The pressing forces are applied by hydraulic cylinders, are measured and finally adjusted to a predetermined minimum force. As a result, the centering of the slab 1 and the driving of the rollers 14 takes place. This centering procedure is carried out slowly and with a continuously forwardly transported slab. In the case of moved slabs, a slight transverse displacement of the slab 1 at low displacement forces can be carried out. The centering procedure should be concluded prior to reaching the second lateral roller guide pair 7, i.e., the second means for exerting a lateral force on the slab. When the slab tip passes the second lateral roller guide, the same centering procedure takes place at that location. If both rollers 14 are centric, a centric entering of the slab into the upsetting stand 15 and into the finishing train 5 is present with a higher probability.

The threading in to the upsetting stand 15 is supported by driving rollers 12 (see FIG. 1) which are integrated into the descaling device 4, at least until the upsetting device 15 or the first stand of the finishing train 5 have started to operate.

The second lateral guide roller pair 7, i.e., the second means for exerting a lateral force on the slab, can—as illustrated—be arranged in front of the descaling device within which the descaling procedure is integrated or arranged behind the descaling device. Optionally, it is also possible to provide a drive of the rollers 14 of the means 6 and 7. The second lateral roller guide 7 can be adjusted in a straight guidance in the width direction (see configuration at the second location 13 in FIG. 2) or by means of a pivot arm (as seen at the first location 12 in FIG. 2).

In an alternative embodiment (not illustrated), instead of a greater lateral roller guidance it is also possible to arrange two smaller double rollers arranged closely next to each other in a guide unit, however, always in such a way that still the short construction is present. Using the two lateral roller guides 6, 7, which are spaced apart from each other, the effect of a long, continuous lateral guidance is achieved. The lateral roller guides, 6, 7 are a unit with respect to control technology.

In the case of a large eccentricity of the slab, or when high displacement forces occur (thicker thin slabs, long slabs, actuators which are too weak, limited displacement forces), it is possible to deviate from the above-described manner of operation of the centric adjustment of both lateral roller guides 6, 7. In this connection, reference is made to FIG. 3 which illustrates the situation in a simplified manner. In this case, the lateral roller guides 6, 7 are positioned in such a way that the slab tip is safely threaded concentrically into upsetting stand 15. The centering effect is thus only carried out partially under certain circumstances. The centric entering of the slab head in the upsetting stand 15 has a higher priority in that case. When knowing the distances a₁ and a₂ (see FIG. 3) between the lateral roller guides 6, 7 and the upsetting stand 15, the roller forces and the computed (small) upsetting reductions at the rollers, the position of the actuators 20, 21 can be determined, so that the mentioned object is met. In this connection, the two positions of the lateral roller guides 6, 7 are adjusted relative to each other. Between the rollers 14 of the means 6, 7 and the rollers of the upsetting stand 15, this results in a straight connecting line.

It must be expected that the slab 1 can assume any curved shape (saber, S-shaped, hook-shaped) and that the slab is placed eccentrically, so that the optimum positioning of the lateral roller guides 6, 7 becomes more complicated. In that case, a determination of the slab shape and the position of the slab length is carried out. For this purpose, laser distance measurements or other position determining signals, for example, in front of the last furnace part (following the ferry) are provided, as illustrated in FIG. 4 concerning the acquisition and determination of the slab shape and the position over the length. Also noted here is in this case the eccentricity Δy of the slab from the axis of the plant.

By means of the acquisition of the transport speed of the slab 1 and the assignment of the measured edge spacing signals by sensors 23 for recognizing the strip edge on both sides of the slab, the width, position or generally the shape of the slab (see items xbᵢ, ybᵢ₎) over the length can be determined. The shape and eccentricity yᵢ determined in this case will later be used for the optimum positioning of the lateral roller guides 6, 7 and/or rollers of the upsetting stand 15. Optionally, an additional slab width and slap positioning acquisition is possible behind the furnace from the sides by means of the sensors 24 or from the sides or from below.

Details concerning the adjustment of the lateral roller guides 6, 7 and the rollers of the upsetting stand 15 can be seen in FIG. 5, where the adjustment of the lateral roller guides and the rollers of the upsetting stand are illustrated, so that even in the case of a curved slab shape, a centric entering of the slab head into the upsetting stand or into the finishing train is ensured.

With the knowledge of the slab shape (items xbᵢ, ybᵢ, and the width B of the slab 1), the positions of the rollers 14 and the rollers of the upsetting stand 15 (X1, Y1; X2, Y2; X3, Y3—in relation to the slab center) can be approached. The positions are adjusted to the respective slab shape when the slab tip travels from the furnace 2 to the first stand of the finishing train 5 and are still being moved, so that it is possible to achieve the goal of guiding the slab tip centrically into the upsetting stand 15. It is also provided in this connection that the rollers of the upsetting stand 15 may be placed asymmetrically, i.e., eccentrically, in order to support the lateral guides 6, 7.

In accordance with the same principle explained above, it may be possible, optionally or additionally, to achieve the concentric entry of the slab tip into the following stand.

After threading the slab 1 into the rolling train 5, there is the object to position or center the roller positioning devices 6, 7 as well as the upsetting stand 15 centrically over the slab length, so that the slab 1 and especially the slab end are placed as evenly as possible, is partially straightened and also enters the rolling train 5 in this manner.

At the slab end, the rollers of the upsetting stand 15 are symmetrically closed (short stroke control) in order to avoid or reduce an excess width of the slab end. A similar procedure is carried out at the slab head.

Alternatively, or additionally to the width measurement, the width or position control can be carried out through the distance pick-ups of the lateral roller guides and/or the upsetting rollers. Moreover, the detected width signal as well as the computed width increase or width change in the finishing train in the width model are used for determining the upsetting value and to control the upsetting stand in this manner.

For increasing the width reduction at the upsetting stand 15, holding-down or clamping rollers are provided which are arranged exactly between the two upsetting rollers and press from above and below in the middle of the slab 1 against the slab surface in order to prevent bulging.

In addition, it may be provided to simplify upsetting of the slab by lubricating the upsetting rolls. This increases the transverse flux of material, reduces the bulging and indentation forces, and has a positive effect on the slab and upsetting roll roughness and, thus, on the service life of the upsetting rolls.

In order to improve the conditions at the slab end and to guide the slab over as long a distance as possible, a special mechanical lateral guidance is additionally provided between the upsetting stand 15 and the first stand of the rolling train 5 (see FIGS. 1 and 2). Details in this connection can be seen in FIGS. 6 and 7. In this connection, it is the object to arrange the upsetting stand 15 closely in front of the first stand of the rolling train 5 and to position the mechanical lateral guidance as closely as possible in front of the roller gap of the first stand. This makes it possible to carry out an adjustment of the mechanical lateral guides, i.e., of the lateral guide rulers 16 and 17 without additional space requirements and without weakening the housing posts of the rolling stand (with recesses therein), advantageously an adjustment below (or optionally also above) the lateral guide rulers 6, 17, as it is shown in FIGS. 6 and 7. It is also possible to alternatively carry out the adjustment of the lateral guide rulers 16, 17 together with the adjustment of the upsetting stand 15. In this case, upsetting stand and guide rulers would be fixedly connected to each other.

The adjustment of the lateral guide rulers 16, 17 is carried out on a guide 27 by the two adjusting elements 26 (cylinders) per side. The adjusting elements 26 are upwardly provided with a heat protection element 25 (cooled transfer table, damping plate). The position of the mechanical lateral guides corresponds during operation to the width position of the upsetting stand 15 plus a defined value (in millimeters).

The method described above and the illustrated arrangement are not limited to a CSP plant, but are also used in similar production plants behind a furnace component. The proposal according to the invention can also be used, for example, in conventional hot strip rolling trains. Here, the preliminary strip shape is detected behind a preliminary stand during the transport in the direction of the finishing train and, with suitable adjustment of rollers prior to the finishing train, the above explained objects are met.

In a conventional hot strip train, the first centering effect prior to the cutting device can also be carried out, alternatively to the use of lateral roller guide unit 6, by guide rulers.

### LIST OF REFERENCE NUMERALS

1. Slab (preliminary strip)
2. Furnace
3. First processing device (cutting device)
4. Second processing device (scaling device)
5. Rolling train
6. First means for exerting a lateral force on the slab (lateral roller guide)
7. Second means for exerting a lateral force on the slab (lateral roller guide)
8. Side of the slab
9. Side of the slab
10. Axis of the slab
11. Axis of the rolling train
12. First location
13. Second location
14. Contact element (roller)
15. Upsetting stand
16. Lateral guide ruler
17. Lateral guide ruler
18. Pivoting arm
19. Bearing point
20. Actuator
21. Linear actuator
22. Drive roller
23. Sensor for recognizing the slab edge
24. Sensor for recognizing the slab edge
25. Heat protection element
26. Adjusting element of the lateral guide ruler
27. Guide
F Conveying direction
Δy Eccentricity
B Width of the slab
x_{B} Length coordinate of the slab
y_{B} Coordinate describing the slab shape

1-32. (canceled)

33. A method of processing a slab in a device which includes at least one furnace, at least one processing device arranged following the furnace in a conveying direction of the slab, and at least one rolling train arranged following the at least one processing device in the conveying direction of the slab, the method comprising exerting a force against sides of the slab in order to move an axis of the slab to coincide with a predetermined position transversely of the conveying direction of the slab, particularly so as to coincide with an axis of the rolling train, the exerting including exerting a lateral force against the slab with first means for exerting force that acts on the slab at a first location, and exerting a lateral force against the slab with second means for exerting a force that acts on the slab on a second location, the second location being spaced apart from the first location in the conveying direction of the slab, the first location being located behind the furnace, and the second location being located in front of, within, or following the at least one processing device.

34. The method according to claim 33, wherein the first location is following the furnace, and in front of a first of the at least one processing device, and the second location is within or following the first of the at least one processing device.

35. The method according to claim 33, wherein rolling in the rolling train is finish-rolling of the slab into a strip.

36. The method according to claim 33, including detecting a position of a head of the slab in an area of at least one of the force exerting means, and starting exertion of a lateral force against the slab by adjusting a contact element of the force exerting means only when the head of the slab has passed the force exerting means.

37. The method according to claim 33, including subjecting the slab to an upsetting step in the direction transversely of the conveying direction immediately in front of the rolling train.

38. The method according to claim 37, wherein the exertion of a lateral force against the slab by the force exerting means takes place in front of the upsetting step and spaced apart from a location of the upsetting step.

39. The method according to claim 33, wherein the exertion of a lateral force against the slab by the force exerting means takes place in front of the rolling train.

40. The method according to claim 38, including operating the means for exerting a lateral force against the slab so that a tip of the slab enters centrally into the upsetting location and/or into the rolling train.

41. The method according to claim 33, wherein at least two processing devices are provided, at least two means for exerting a lateral force against the slab being arranged following the furnace, wherein the first location is situated between the furnace and a first processing device and the second location is situated between the at least two processing devices or within a second processing device.

42. The method according to claim 41, including subjecting the slab to a shearing process in the first processing device.

43. The method according to claim 41, including subjecting the slab to a descaling process in the second processing device.

44. The method according to claim 33, including determining location and/or shape of the slab transversely of the conveying direction of the slab along movement of the slab in the conveying direction in front of the first location.

45. The method according to claim 33, wherein the exertion of a lateral force against slab by the force exerting means takes place in a controlled or regulated manner that the axis of the slab assumes in the conveying direction a desired position behind the second location.

46. The method according to claim 44, including determining, using a computer model, adjustment of the means for exerting a lateral force against the slab in dependence on geometry of the device and/or determined shape of the slab and/or eccentricity of the slab and/or width of the slab.

47. A device for processing a slab, comprising: at least one furnace; at least one processing device arranged following the furnace in a conveying direction of the slab; a rolling train arranged following the at least one processing device in the conveying direction of the slab; and means for exerting a force against sides of the slab, for moving an axis of the slab to coincide with a predetermined position transversely of the conveying direction of the slab, in particular for coinciding with an axis of the rolling train, the force exerting means including first means for exerting a lateral force against the slab arranged at a first location and second means for exerting a lateral force against slab arranged at a second location, wherein the second location is spaced from the first location in the conveying direction of the slab, wherein the first location is situated following the furnace, and the second location is situated in front of, within or following the at least one processing device.

48. The device according to claim 47, wherein the first location is situated following the furnace and in front of the at least one processing device, and the second location is situated within or following a first of the at least one processing device.

49. The device according to claim 47, wherein an area within the furnace is free of means for exerting a lateral force against the slab.

50. The device according to claim 47, further comprising an upsetting stand arranged immediately in front of the rolling train for upsetting the slab in the direction transversely of the conveying direction.

51. The device according to claim 50, further comprising lateral guide rulers arranged between the upsetting stand and the first roll stand of the rolling train for centering and guiding the slab.

52. The device according to claim 51, wherein the lateral guide rulers have adjusting elements arranged under and/or above the lateral guide rulers.

53. The device according to claim 50, wherein the means for exerting a lateral force against the slab are arranged spaced apart from the upsetting stand.

54. The device according to claim 47, wherein the means for exerting a lateral force against the slab are arranged in front of the rolling train.

55. The device according to claim 47, including at least two processing devices, wherein at least two means for exerting a lateral force against slab are arranged following the furnace, wherein the first location is situated between the furnace and a first processing device, and the second location is situated between the at least two processing devices or within a second processing device.

56. The device according to claim 55, wherein the first processing device is a cutting device.

57. The device according to claim 55, wherein the second processing device is a descaling device.

58. The device according to claim 47, wherein the means for exerting a lateral force against the slab includes at least one roller arranged at a pivoting arm, wherein the pivoting arm is mounted at a stationary bearing point, and further comprising an actuator that acts on the pivoting arm outside of the bearing point so as to pivot the pivoting arm.

59. The device according to claim 47, wherein the means for exerting a lateral force against the slab includes at least one roller arranged at a linear actuator whose direction of movement is aligned transversely of the conveying direction of the slab.

60. The device according to claim 58, wherein the actuator is a hydraulic piston-cylinder system.

61. The device according to claim 59, wherein the linear actuator is a hydraulic piston-cylinder system.

62. The device according to claim 33, wherein the first means for exerting a lateral force against the slab are constructed as guide rulers.

63. The device according to claim 47, wherein the device is a component of a thin slab continuous casting plant.

64. The device according to claim 47, wherein the device is a component of a hot strip train which includes a preliminary train and a finishing train.

65. The device according to claim 64, wherein the device is arranged in front of the finishing train.
